(19) United States
(12) Patent Application Publication
(10) Pub. No.: US 2006/0012817 A1
(43) Pub. Date: Jan. 19, 2006

(54) Integrated tab and slip sheet editing and automatic printing workflow

(75) Inventor: Qiming (James) Wu, Fairport, NY (US)

Correspondence Address: John S. Zanghi, Esq.;FAY, SHARPE, FAGAN, MINNICH & McKEE, LLP, SEVENTH FLOOR, 1100 SUPERIOR AVENUE, CLEVELAND, OH, 44114-2579, US

(73) Assignee: Xerox Corporation

(21) Appl. No.: 10/977,563

(22) Filed: Oct. 29, 2004

Related U.S. Application Data
(60) Provisional application No. 60/587,737, filed on Jul. 14, 2004.

(51) Int. Cl. G06F 15/00

(52) U.S. Cl. 358/1.13

(57) ABSTRACT

A digital publishing and printing process comprising receiving input from a user via a graphical user interface, wherein the input includes a request to insert a plurality of document inserts within or between a plurality of source documents; generating from the input a data control file containing the meta data of the source documents; assembling the source documents based on the data control file; generating an output document in PDF format that contains the document inserts which are displayed in a visualized way; and printing the output document.

This application claims priority from U.S. Provisional Application Ser. No. 60/587,737, filed on Jul. 14, 2004.

### BACKGROUND

The present exemplary embodiment relates to digital publishing and printing. It finds particular application in conjunction with tab and slip sheet insertion, editing, and printing, and will be described with particular reference thereto. However, it is to be appreciated that the present exemplary embodiment is also amenable to other like applications.

Tab and slip sheet insertion, editing and automatic printing have been a challenge to the digital publishing and printing workflow. The current solutions on the market are far from meeting the needs of digital publishing and printing business. Many companies and commercial printing houses either have to print tabs and slip sheets in a separate process from the main document printing and then manually insert tabs and slip sheets into the main documents, which is extremely time consuming, or go through a complicated process of print job configuration to get limited automatic tab/slip sheet printing.

Thus, there is a need for a set of software components that provide a visual, simple, flexible, and fully integrated workflow of tab and slip sheet insertion, editing, viewing and printing.

### BRIEF DESCRIPTION

In one embodiment there is provided a digital publishing and printing process. The process comprises receiving input from a user via a graphical user interface, wherein the input includes a request to insert a plurality of document inserts within or between a plurality of source documents; generating from the input a data control file containing the meta data of the source documents; assembling the source documents based on the data control file; generating an output document in PDF format that contains the document inserts which are displayed in a visualized way; and printing the output document.

In another embodiment, there is provided a digital publishing and printing system. The system comprises means for receiving input from a user, wherein the input includes a request to insert a plurality of document inserts within or between a plurality of source documents; means for generating from the input a data control file containing the meta data of the source documents; means for assembling the source documents based on the data control file; means for generating an output document in PDF format that contains the document inserts which are displayed in a visualized way; and means for printing the output document.

In yet another embodiment there is provided in yet another embodiment there is provided a digital publishing and printing apparatus in an enterprise print system. The apparatus comprises a graphical user interface for receiving input from a user, wherein the input includes a request to insert a plurality of document inserts within or between a plurality of source documents; a document assembler for assembling the source documents and generating a viewable file containing the document inserts which are displayed in a visualized way; a print pre-processor for converting the viewable file generated by the document assembler into a printable file; and a printer.

### BRIEF DESCRIPTION OF THE DRAWINGS

FIG. 1 is a block diagram of an integrated tab and slip sheet editing and printing system.

FIG. 2 is a screen shot of a visual tab and slip sheet editor.

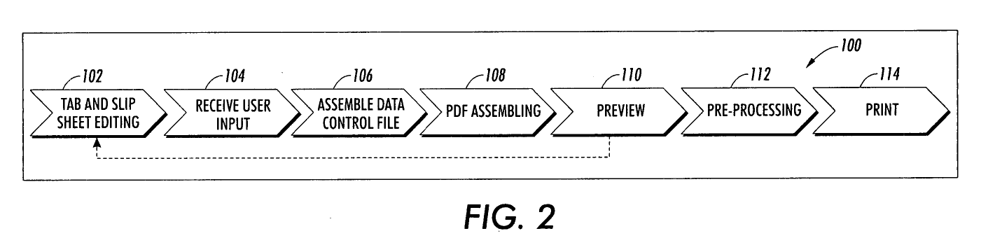

FIG. 3 is a screen shot of a PDF file containing inserted tab and slip sheets.

FIG. 4 is a flow diagram for a process of integrated tab and slip sheet editing and printing.

FIG. 5 is a block diagram of a computer system on which the process of FIG. 4

### DETAILED DESCRIPTION

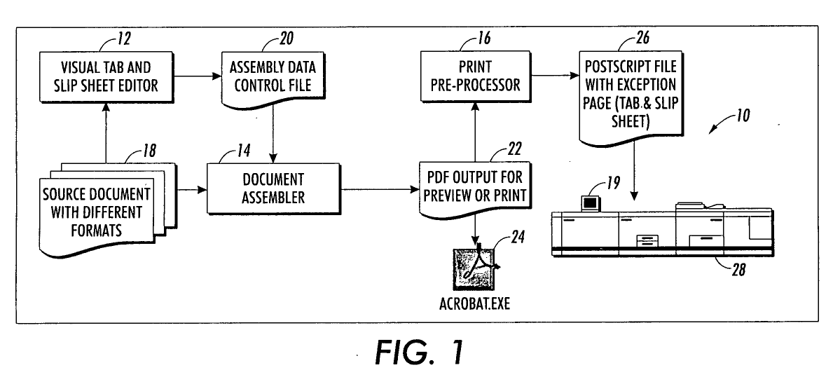

Referring to FIG. 1, there is shown an integrated tab and slip sheeting editing and automatic printing system 10. The system 10 consists of three integrated software components: a visual tab and slip sheet editor 12, a document assembler 14 and a print pre-processor 16, which work together to provide a simple integrated workflow.

The visual editor 12 is a graphical user interface (GUI) which allows a user (not shown) to perform tab and/or slip sheet insertion, editing, removing and tab text editing and formatting for a source document (or documents) 18 via a computer 19. The visual editor 12 allows the user to work with multiple source documents 18 with different formats. The user can insert tabs and/or slip sheets within a single document as well as between documents. The visual editor 12 displays the whole document assembly tree together with inserted tabs and/or slip sheets. The visual editor 12 also displays the tab text in a “what you see is what you get” (WYSIWYG) format. The visual editor 12 also provides a preview for users to view the output. The visual editor 12 generates a data control file 20, which contains the meta data of the source document(s) and the tabs and/or slip sheets to be inserted. In this case, meta data contain source document(s) assembly information, tab/slip-sheet page and position information and the text contents of each tab along with the text formatting information such as font type, font size, font color and text alignment and so on.

The document assembler 14 assembles the source document(s) and generates a viewable file 22, such as a Portable Document Format (PDF) file, that contains the inserted tabs and/or slip sheets based on the data control file generated by the visual editor 12. PDF is a well known file format developed by Adobe Systems, San Jose, Calif., for representing documents in a manner that is independent of the original application software, hardware, and operating system used to create those documents. In this embodiment, a PDF file works well because it can describe documents containing any combination of text, graphics, and images in a device independent and resolution independent format. Thus, the source document 18 can be one page or thousands of pages, very simple or extremely complex with a rich use of fonts, graphics, color, and images.

The PDF file 22 can be used for preview or print. The PDF file 22 contains inserted tab and/or slip sheets with a graphic representation of the tab shape and the tab text. The tab shape drawing is only for viewing and will not be printed. The PDF file also includes embedded print instructions for exception page handling, which will be used by the print pre-processor 16 to generate a print job ticket.

The document assembler 14 is invoked when the user wants to preview or print the source documents with inserted tabs and slip sheets. A PDF viewer 24, such as Adobe Acrobat 6.0 or Adobe Reader (both of which are from Adobe Systems), will be automatically invoked when a “Preview” button in the visual editor 12 is pressed.

The print pre-processor 16 converts the PDF document generated by the document assembler 14 into a file that is suitable for printing, such as a PostScript file 26. PostScript is primarily a language for printing documents on laser printers, but it can be adapted to produce images on other types of devices. PostScript is the standard for desktop publishing because it is supported by imagesetters, the very high-resolution printers used by service bureaus to produce camera-ready copy. PostScript is an object-oriented language, meaning that it treats images, including fonts, as collections of geometrical objects rather than as bit maps. Given a single typeface definition, a PostScript printer can produce a multitude of fonts. In contrast, many non-PostScript printers represent fonts with bit maps. To print a bit-mapped typeface with different sizes, these printers require a complete set of bit maps for each size.

The print pre-processor 16 also extract the embedded tab and slip sheet data to generate Exception Page Print Instructions and prefix the instructions at the beginning of the PostScript file for automatic tab and/or slip sheet printing. The PostScript file 26 may be sent to a printing system 28, such as the DocuTech 6135 Production Publisher and PowerPlus Series or the DocuTech 135 Production Publisher, both of which are manufactured by Xerox Corporation of Stamford, Conn. It is to be appreciated by those skilled in the art, however, that other suitable printing systems may used.

The three main software components, i.e., the visual tab and slip sheet editor 12, the document assembler 14 and the print pre-processor 16, can be deployed in a stand alone application, a solution suite, or a client/server application. In the latter case, the visual editor 12 is typically deployed in the client side, while the print pre-processor 16 is deployed in the server side. The document assembler 14 can be deployed in either or both sides.

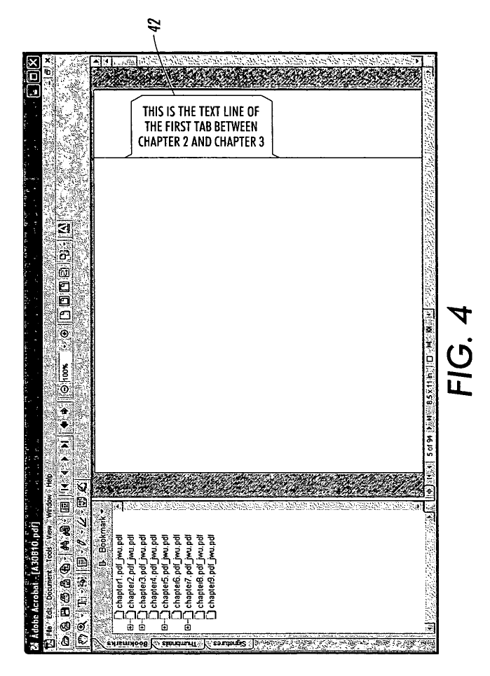

Referring to FIG. 4, an integrated workflow process 100 to edit and print tab and slip sheets within documents is shown. The process 100 may be implemented in any number of printing software systems, such as XPrint from Xerox Corporation, Stamford, Conn. XPrint is an enterprise print system software that prints large and complex documents from Electronic Document Management Systems (EDMS) with high volumes at high speeds and accuracy. XPrint is also an enterprise document management system that provides a common interface to various EDMS, and a set of features for content management and content integration.

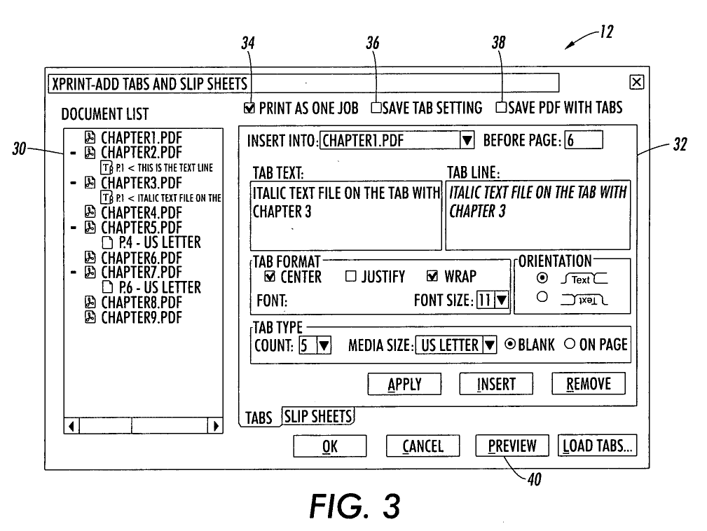

Referring now to FIG. 3, the user, via the graphical user interface, i.e., the visual editor 12, conducts tab and/or slip sheet editing (102), and the user input is received by the system 10 (104). During these steps, the visual editor 12 displays the document list 30, which displays the whole document assembly tree together with inserted tabs and/or slip sheets. By inputting information into a tab editing box 32, the user may: (a) specify where to insert tabs within or between the documents, (b) type the tab text that is to be added, (c) format the tab text, and/or (d) specify the tab type, e.g., the count and media size.

Although not shown, it is to be appreciated that there is a similar slip sheet editing dialog box, which generally allows the user to input the pertinent information for slip sheets. Thus, for example, the user may enter the type of sheet to be entered (white, blue, pink, etc.) as well as the size of the paper. The user may also specify various printing options such as “blank sheet” (nothing is printed on the page), “page on sheet” (allows the page to be printed on), or “bleed tab allowed” (the tab information may be printed in reverse off the edge of the page so that it can be seen as a tabbed page when the printed document is closed).

Once the pertinent data has been entered by the user, the user may choose to select a “print as one job” box 34, by which the system 10 will assemble the source documents, including tabs and/or slip sheets, into a single PDF file and send a single print job to the printer 28, a “save tab setting” box 36, by which the system 10 will save the tab and slip sheets meta data to be associated with the source document in the document management system, and/or a “save PDF with tabs” box 38, by which the system 10 will save the generated PDF output file for later printing.

Next, the visual editor 12 generates a data control file 20, which contains the meta data of the source documents and inserted tab and slip sheets data (106). The data control file 20 can be either in text format or XML format. Based on the control data generated by the visual editor 12, the document assembler 14 assembles the source documents and generates one (if “print as one job” is selected) or multiple PDF output documents containing inserted tabs and slip sheets (108).

The document assembly step 108 can be further divided into the following steps: (1) the system 10 retrieves the source documents from local or remote document repository systems and sends them to a working folder; (2) the system 10 converts non-PDF source documents into PDF files; (3) the system 10 invokes the document assembler 14 with the inputs of the data control file 20 and source documents paths; (4) the document assembler 14 opens and reads in all the source documents and the data control file and generates one (or multiple) PDF output file(s) containing tabs and/or slip sheets.

At this point, the user clicks the “Preview” button 40 to preview the PDF document (110). FIG. 4 is a sample screen shot of a preview of the new tab 42. The user may edit the inserted tab(s) and/or slip sheet(s), as necessary. Next, the document 18 goes through pre-processing (112). In this process, the print pre-processor 16 reads in the PDF output file and extracts the tab and slip sheets information embedded in the file, converts the PDF file into a PostScript file, and then creates the print instruction including exception page handling (print job ticket) and prefixes the print instruction in the PostScript file for printing. Finally, the PostScript file containing the printing instruction at front is sent to the printer 28 (114).

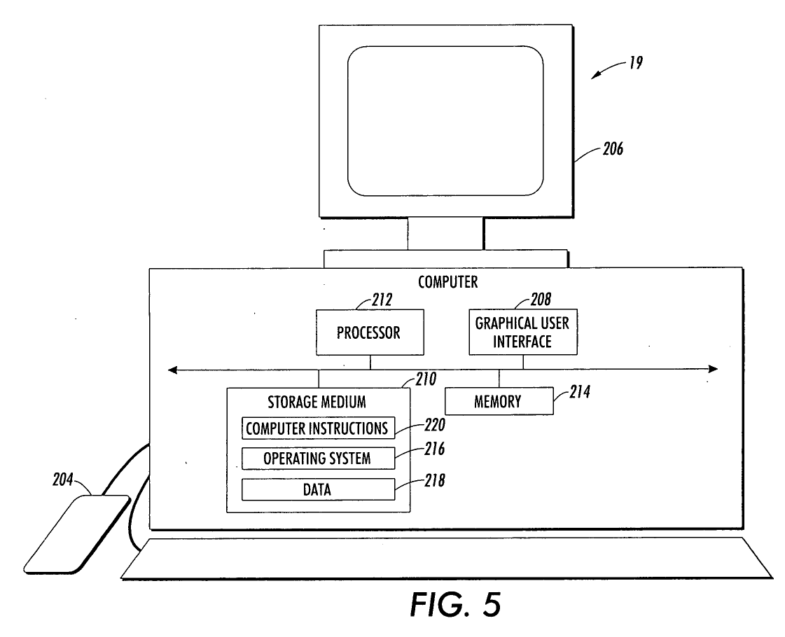

FIG. 5 shows the computer 19 with a mouse 204, a monitor 206, and a graphical user interface 208, such as the visual editor 12, for implementing the integrated workflow process 100. The computer 202 includes a storage medium 210 (e.g., hard disk), a processor 212, and a memory 214 for operating the visual editor 12. The storage medium 210 stores an operating system 216, data 218, and computer instructions 220 that are executed by the processor 212 out of the memory 214 to perform the process 100.

In this embodiment, the software program is written in C++ in Windows platform. It can also be implemented in Java or C# language and in other operating systems such as UNIX and Linux. The process 100 is not limited to use with the hardware and software of FIG. 5, and it may find applicability in any computing or processing environment and with any type of machine that is capable of running a computer program. The process 100 may be implemented in hardware, software, or a combination of the two. The process 100 may be implemented in computer programs executed on programmable computers/machines that each includes a processor, a storage medium/article readable by the processor (including volatile and non-volatile memory and/or storage elements), at least one input device, and one or more output devices. Program code may be applied to data entered using an input device to perform the process 100 and to generate output information.

Each computer program may be stored on a storage medium (article) or device (e.g., CD-ROM, hard disk, or magnetic diskette) that is readable by a general or special purpose programmable computer for configuring and operating the computer when the storage medium or device is read by the computer to perform the process. The process may also be implemented as a machine-readable storage medium, configured with a computer program, where upon execution, instructions in the computer program cause the computer to operate in accordance with the process 100.

It is to be appreciated that this integrated workflow process can also work with any of the well known document repository systems, such as Documentum from EMC Corporation and Livelink from Open Text Corporation. In such environments, the control data file can be stored as a rendition of the source document and can be retrieved later for PDF generation for preview or printing.

In summary, the embodiments described above provide for three integrated software components to support tab/slip sheet insertion, editing, viewing, and printing: a visual tab and slip sheet editor, a document assembler, and a print pre-processor. The visual tab and slip sheet editor provides a graphical user interface that allows the user to edit and insert tabs/slip sheets. The visual editor generates assembly control data containing metadata for the specified source documents and tab/slip sheets. The document assembler uses the assembly control data generated by the editor to generate a PDF output document that contains the tab/slip sheets, as well as a graphic presentation of the tab shape and text. The document assembler also embeds print instructions for exception page handling. Using the visual editor, the user may then preview the generated PDF assembly. For printing, the print pre-processor converts the PDF document generated by the assembler into a print ready postscript file. The print pre-processor also extracts the tab/slip sheet data to generate Exception Page Print instructions. Thus, this is a fully integrated system for tab/slip sheet insertion, editing, viewing, and printing. Further, the three components can be deployed in a stand alone application, a solution suite, or as a client/server application. The components enable visual, simple, and flexible workflow for tab/slip sheet insertion, editing, viewing and printing. This is an effective system providing improved tab and slip sheet printing capability.

Obviously, modifications and alterations will occur to others upon reading and understanding the preceding detailed description. It is intended that the exemplary embodiments be construed as including all such modifications and alterations insofar as they come within the scope of the appended claims or the equivalents thereof.

1. A digital publishing and printing process comprising:
receiving input from a user via a graphical user interface, wherein the input includes a request to insert a plurality of document inserts within or between a plurality of source documents;
generating from the input a data control file containing the meta data of the source documents;
assembling the source documents based on the data control file;
generating an output document in PDF format that contains the document inserts which are displayed in a visualized way; and
printing the output document.

2. The process defined in claim 1, wherein at least one of the document inserts is a tab.

3. The process defined in claim 1, wherein at least one of the document inserts is a slip sheet.

4. The process defined in claim 1, further comprising:
retrieving the source documents from a document repository system and sending it to a working folder;
converting non-PDF source documents into PDF files;
invoking a document assembler with the meta data of the control file and source documents paths; and
using the document assembler to open and read in all the source documents and the control file and generate at least one PDF output file containing at least one special insert.

5. The process defined in claim 1, wherein the graphical user interface includes means for allowing the user to edit the document inserts.

6. The process defined in claim 1, wherein the meta data includes source documents assembly information, page and position information for the special insert, and text that is to be printed on the document inserts.

7. A digital publishing and printing system comprising:
means for receiving input from a user, wherein the input includes a request to insert a plurality of document inserts within or between a plurality of source documents;
means for generating from the input a data control file containing the meta data of the source documents;
means for assembling the source documents based on the data control file;
means for generating an output document in PDF format that contains the document inserts which are displayed in a visualized way; and
means for printing the output document.

8. The system defined in claim 7, wherein at least one of the document inserts is a tab.

9. The system defined in claim 7, wherein at least one of the document insert s is a slip sheet.

10. The system defined in claim 7, further comprising:
means for retrieving the source documents from a document repository system and sending it to a working folder;
means for converting non-PDF source documents into PDF files;
means for invoking a document assembler with the meta data of the control file and source documents paths;
means for opening and reading in all the source documents and the control file and generating at least one PDF output file containing at least one special insert.

11. The system defined in claim 1, further including means for allowing the user to edit the document inserts.

12. The system defined in claim 1, wherein the meta data includes source documents assembly information, page and position information for the document inserts, and text that is to be printed on the document inserts.

13. A digital publishing and printing apparatus in an enterprise print system, the apparatus comprising:
a graphical user interface for receiving input from a user, wherein the input includes a request to insert a plurality of document inserts within or between a plurality of source documents;
a document assembler for assembling the source documents and generating a viewable file containing the document inserts which are displayed in a visualized way;
a print pre-processor for converting the viewable file generated by the document assembler into a printable file; and
a printer.

14. The system defined in claim 13, wherein at least one of the document inserts comprises a tab.

15. The system defined in claim 13, wherein at least one of the document inserts is a slip sheet.

16. The system defined in claim 13, wherein the graphical user interface includes means for allowing the user to insert, edit, preview and print the document inserts.

17. The system defined in claim 13, wherein the viewable file is a Portable Document Format (PDF) file.

18. The system defined in claim 13, wherein the printable file is a PostScript file.

19. The system defined in claim 18, wherein the printable file is a PostScript file.

20. The system defined in claim 19, wherein the enterprise print system is XPrint.
